(19) United States
(12) Patent Application Publication
(10) Pub. No.: US 2007/0086105 A1
(43) Pub. Date: Apr. 19, 2007

(54) Quiet movie playback for entertainment PC

(75) Inventors: Sek Ng, Round Rock, TX (US); Mohammed K. Hijazi, Austin, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 11/251,513

(22) Filed: Oct. 14, 2005

(51) Int. Cl. G11B 15/18

(52) U.S. Cl. 360/71

(57) ABSTRACT

An entertainment system includes an optical media drive operable to playback contents of an optical media and a storage device (SD) to store data. The SD includes a head to read and write the data, a detector input to detect the playback of the optical media and a control output to move the head in a predefined motion in response to the playback. The predefined motion, which occurs continuously at a predefined constant speed, prevents the SD from generating an unsolicited sound during the playback, thereby improving the multimedia experience. The predefined motion is disabled when the playback is disabled.

### BACKGROUND

The present disclosure relates generally to information handling systems, and more particularly to tools and techniques for enhancing multimedia experience of entertainment system applications.

As the value and use of information continues to increase, individuals and businesses seek additional ways to acquire, process and store information. One option available to users is information handling systems. An information handling system (‘IHS’) generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, entertainment, and/or global communications. In addition, information handling systems may include a variety of hardware and software components that may be configured to process, store, and communicate information and may include one or more computer systems, data storage systems, and networking systems.

Presently, due to advances in multimedia applications such as optical media based feature films and/or electronic video games deploying the latest in audiovisual effects, users are able to enjoy theater-like surround sound experience on their IHS systems including notebook computers and/or proprietary entertainment boxes.

Multi-media entertainment systems have evolved from earlier generation electronic components such as digital video disc (DVD) players, television (TV) monitors, stereo amplifiers, speakers manually interconnected as a system to the present, fully integrated, computer based digital plug-n-play, entertainment systems equipped with high definition (HD) large screen monitors, DVD player/recorder and surround sound speakers. For experiencing theatre-like movie presentations on these entertainment systems, it is desirable that the audio output of the computer based entertainment system be a true representation of the recorded audio track of the multimedia application such as a movie. That is, it is desirable that the audio output of the entertainment system exclude unsolicited and/or undesirable sounds such as a clicking noise commonly produced by storage media devices such as hard disk drives (HDD) included with the entertainment system.

Most multimedia devices available today include a power management system to conserve power. During a power conservation mode, HDD heads are often parked due to inactivity. Frequent services of the file system and other software routines that access the HDD content may cause the HDD heads to change from the parked position and load onto the magnetic media. Thus, the process of loading and unloading the HDD heads typically generates the clicking noise that may interfere with the user experience when watching DVD movies.

Therefore, a need exists to provide for enhancing multimedia entertainment system applications. Accordingly, it would be desirable to provide a method and system for improved control of the HDD while playing DVD movies using an information handling system absent the disadvantages found in the prior methods discussed above.

### SUMMARY

The foregoing need is addressed by the teachings of the present disclosure, which relates to a controller to control a storage device comprising a detector input to detect playback of an optical media and a control output to move a head of the storage device in a predetermined motion in response to the playback.

A method for controlling the storage device comprises receiving a detector input indicative of a playback of an optical media and adjusting a head of the storage device to move in a predefined motion in response to the playback.

In one application, an information handling system (IHS) comprises a processor, an optical media drive coupled to the processor, wherein the optical media drive is operable to playback contents of an optical media, and a storage device (SD) coupled to the processor, the SD including a head to read and write data, a detector input to detect the playback, and a control output to move the head in a predefined motion in response to the playback.

### BRIEF DESCRIPTION OF THE DRAWINGS

FIG. 1 illustrates a block diagram of an information handling system 100 having an improved storage device, according to an embodiment;

FIG. 2 is a view in perspective illustrating further details of an improved storage device described with reference to FIG. 1, according to an embodiment;

FIG. 3 shows detail of a controller to control motion of a head of a hard disk drive, according to an embodiment; and

FIG. 4 is a flow chart illustrating a method for controlling a storage device, according to an embodiment.

### DETAILED DESCRIPTION

Novel features believed characteristic of the present disclosure are set forth in the appended claims. The disclosure itself, however, as well as a preferred mode of use, various objectives and advantages thereof, will best be understood by reference to the following detailed description of an illustrative embodiment when read in conjunction with the accompanying drawings. The functionality of various circuits, devices, boards, cards, modules, blocks, and/ or components described herein may be implemented as hardware (including discrete components, integrated circuits and systems-on-a-chip ‘SOC’), firmware (including application specific integrated circuits and programmable chips) and/or software or a combination thereof, depending on the application requirements.

Information handling system (IHS) may be deployed in various applications, including entertainment systems. The IHS may be equipped with high definition (HD) large screen monitors, DVD player/recorder and surround sound speakers for delivering a theatre-like movie experience. For these entertainment systems, it is desirable that the audio output of the computer based entertainment system be a true representation of the recorded audio track of the movie. That is, it is desirable that the audio output of the entertainment system exclude unsolicited and/or undesirable sounds such as a clicking or chirping noise commonly produced by storage media devices such as hard disk drives (HDD) included with the entertainment system. Presently, no tools and/or techniques exist to automatically control generation of clicking noises while playing a movie on a DVD player/recorder. As a result, many viewers may not fully benefit from the theatre-like performance entertainment systems due to undesirable noises. Thus, a need exists to provide an improved method and system for enhanced multimedia experience of entertainment system applications.

According to one embodiment, in a method and system for improving multimedia experience, an entertainment system includes an optical media drive operable to playback contents of an optical media and a storage device (SD) to store data. The SD includes a head to read and write the data, a detector input to detect the playback of the optical media and a control output to move the head in a predefined motion in response to the playback. The predefined motion, which occurs continuously at a predefined constant speed, prevents the SD from generating an unsolicited sound during the playback, thereby improving the multimedia experience. The predefined motion is disabled when the playback is disabled.

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, the IHS may be a personal computer, including notebook computers, personal digital assistants, cellular phones, gaming consoles, a network storage device, or any other suitable device and may vary in size, shape, performance, functionality, and price. The information handling system may include random access memory (RAM), one or more processing resources such as central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to receive/transmit communications between the various hardware components.

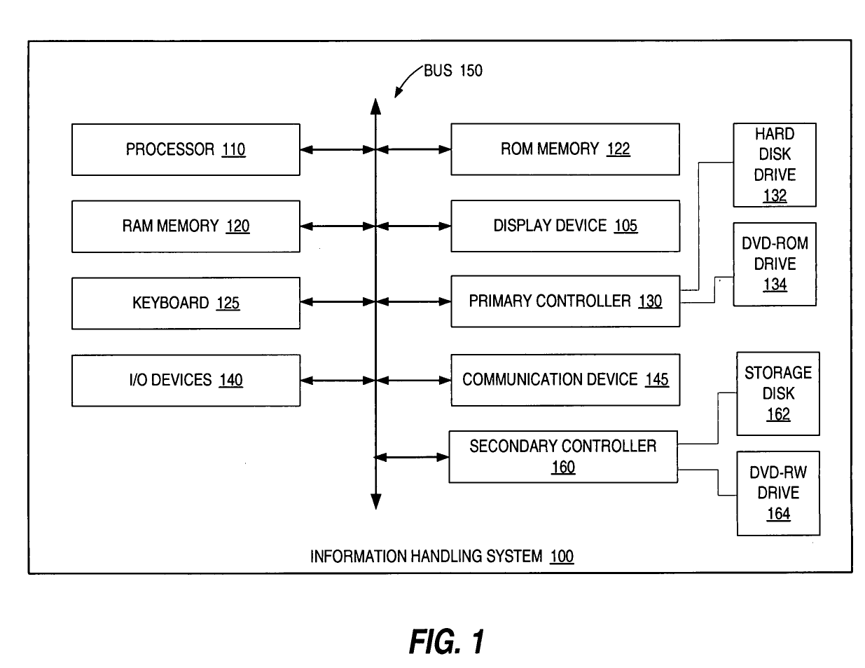

FIG. 1 illustrates a block diagram of an information handling system 100 having an improved storage device, according to an embodiment. The information handling system 100 having the improved storage device includes a processor 110, a system random access memory (RAM) 120 (also referred to as main memory), a non-volatile ROM 122 memory, a display device 105, a keyboard 125 and an I/O controller 140 for controlling various other input/output devices. For example, the I/O controller 140 may include a keyboard controller, a cursor device controller and/or the serial I/O controller. It should be understood that the term “information handling system” is intended to encompass any device having a processor that executes instructions from a memory medium.

Data storage systems or storage devices are devices capable of storing data and/or information. The term storage device (SD) generally refers to mass storage devices, such as hard disk drives (HDD), tape drives, micro-floppy drives, removable cartridge HDD, removable flash memory devices, and optical media drives such as CD-ROM drives and/or DVD drives. The SD may be compliant with well known standards such as the Integrated Drive Electronics/AT Attachment (IDE/ATA) standard and/or may use proprietary standards.

The IHS 100 is shown to include a primary controller (PCTR) 130 configured as a primary controller and a secondary controller (SCTR) 160 configured as a secondary controller. In the depicted embodiment, the PCTR 130 controls two channels (master/slave) connected to an improved SD such as a HDD 132 and an optical media drive such as a DVD-ROM drive 134. Similarly, the SCTR 160 controls two channels (master/slave) connected to a storage disk 162 and a DVD-RW drive 164. The PCTR 130 and/or the SCTR 160 controller adjusts data transfer rate to the slowest device connected to the channel. That is, when the controller scales back data transfer rate to match the specification of the optical media drive then the performance of the HDD may be affected. The use of dual controllers having a dedicated channel each for HDD and optical media drive may alleviate the data transfer rate limitation. In an exemplary, non depicted embodiment, the IHS 100 may not include the SCTR 160. In a particular embodiment, the IHS 100 may include additional controllers and channels.

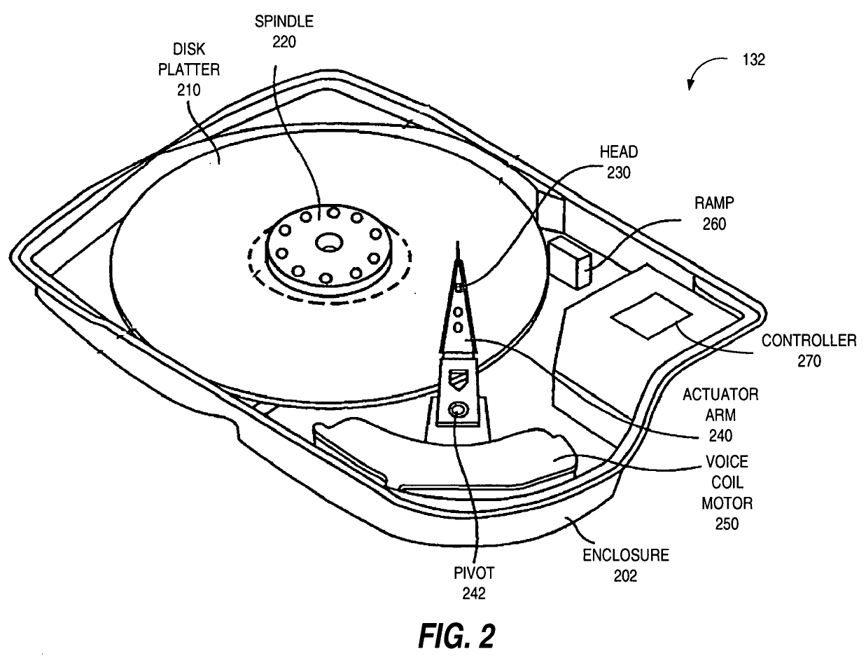

The processor 110 communicates with the system components via a bus 150, which includes data, address and control lines. In one embodiment, the IHS 100 may include multiple instances of the bus 150. A communications device 145, such as a network interface card and/or a radio device, may be connected to the bus 150 to enable wired and/or wireless information exchange between the IHS 100 and other devices (not shown). In the depicted embodiment, the HDD 132 includes an improved technique to control undesirable clicking noises generated by components of the HDD, especially during a playback of a movie on the DVD-ROM drive 134. Additional detail of the improved storage device such as the HDD 132 is described with reference to FIG. 2.

The processor 110 is operable to execute the computing instructions and/or operations of the IHS 100. The memory medium, e.g., RAM 120, preferably stores instructions (also known as a “software program”) for implementing various embodiments of a method in accordance with the present disclosure. An operating system (OS) of the IHS 100 is a type of software program that controls execution of other software programs, referred to as application software programs. For example, in a multimedia application, the processor 110 may direct the HDD 132 to control the clicking noise during playback of the movie on the DVD-ROM drive 134. In various embodiments the instructions and/or software programs may be implemented in various ways, including procedure-based techniques, component-based techniques, and/or object-oriented techniques, among others. Specific examples include assembler, C, XML, C++ objects, Java and Microsoft Foundation Classes (MFC).

FIG. 2 is a view in perspective illustrating further details of an improved storage device described with reference to FIG. 1, according to an embodiment. In the depicted embodiment, the improved SD is the HDD 132 that stores data and/or information by applying a magnetic field to the moving surface of a disk platter 210 coated on one or both sides with a magnetic material. The disk platter 210 is coupled to a spindle 220 rotating at a predefined rotational speed powered by a spindle motor (not shown). In an exemplary, non-depicted embodiment, the HDD 132 may include a plurality of disk platters. The HDD 132 is enclosed in a sealable enclosure 202 to protect its contents.

A head 230 is used to read and/or write data to the disk platter 210. Each side of a plurality of disk platters may include a corresponding head to read and/or write data. The disk platter 210 stores data on a plurality of tracks and sectors. In an exemplary, non-depicted embodiment, the head 230 includes a write element for converting an electric signal into a magnetic field according to the data to be stored on the disk platter 210, and/or a read element for converting a magnetic field received from the disk platter 210 into an electric signal. An actuator assembly supporting the head 230 includes a shock resistant, actuator arm 240 moveable around a pivot 242 and a voice coil motor (VCM) 250. The HDD 132 includes a controller 270 to control various functions such as rotational speed, head positioning, performing load/unload operation, and power management. When an operating system of the IHS 100 requests a read or write data stored on the HDD 132, the processor 110 sends a command to the controller 270 through the PCTR 130 controller. The controller 270 then sends commands to the actuator arm 240 and the VCM 250 to position the head 230 above the predefined track/sector of the disk platter 210 containing the data. The data is read from the disk platter 210 and sent to the operating system through the PCTR 130 controller.

In the depicted embodiment, the HDD 132 incorporates a ramp load/unload technology for the head 230 compared to a traditional landing or take off zone for conventional heads. When the rotational speed of the disk platter 210 decreases below a threshold level, the actuator assembly retracts the head 230 from the data area of the disk platter 210 and parks the actuator arm 240, and hence the head 230, safely onto a ramp 260.

In an exemplary, non-depicted embodiment, one or more of the functions performed by the controller 270 may be performed by another dedicated device located within the HDD 132 such as a power management chip or located external to the HDD 132 such as the PCTR 130. During periods of inactivity the controller 270 places the HDD 132 in a standby mode to conserve power and the HDD 132 may be powered down. Just prior to entering the standby mode of operation, the head 230 is unloaded or parked onto the ramp 260 positioned at the outer edge of the disk platter 210.

Each load and/or unload operation of the head 230 onto the ramp 260 generates or emits an undesirable and/or unwanted sound such as a clicking and/or chirping noise. The clicking noise is a nuisance to users of IHS 100 based entertainment systems executing a multimedia application such as viewing a movie on the DVD-ROM drive 134. The clicking noise may become more pronounced and hence more annoying during periods of silence and/or when there is low sound output by the entertainment system.

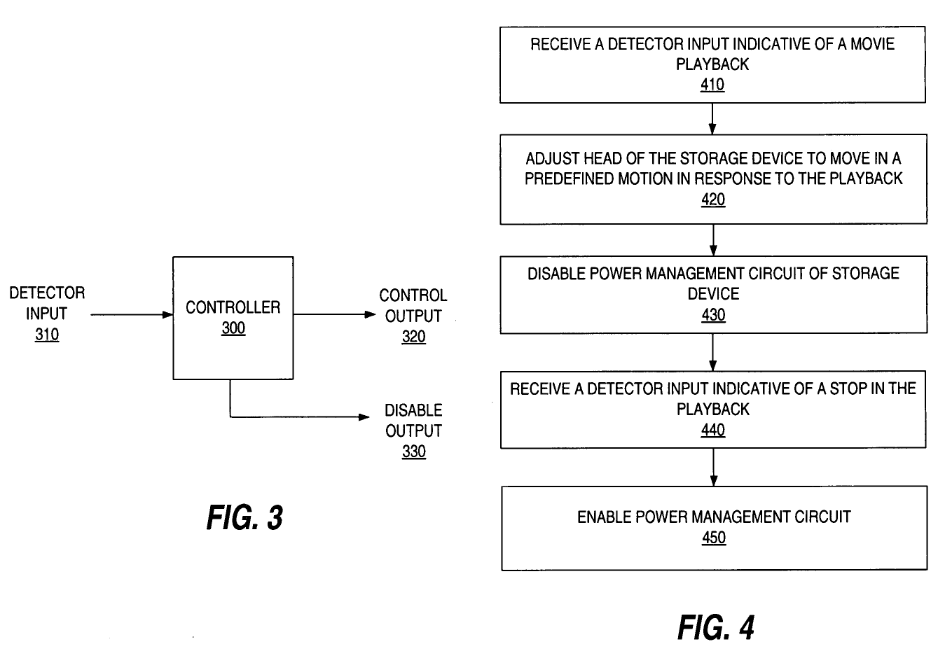

In the depicted embodiment, the clicking noise emitted by the load/unload operation of the head 230 especially during playback of a movie is virtually eliminated by continuously moving the head 230 in a predefined motion in response to the playback. Additional detail of controlling movement of the head 230 to prevent its parking onto the ramp 260 is described with reference to FIG. 3.

FIG. 3 shows detail of a controller 300 to control motion of a head of a HDD, according to an embodiment. In the depicted embodiment, the controller 300 controls the motion of the head 230 of the HDD 132. An implementation of the functionality of the controller 300 is flexible and may be centralized in one device and/or be distributed across multiple devices. In a particular embodiment, the controller 300 is substantially the same as the controller 270 described with reference to FIG. 2, or may be substantially the same as PCTR 130 controller described with reference to FIG. 1, or may be a combination thereof. Referring to FIG. 3 and FIG. 2, the controller 300 is substantially the same as the controller 270 and includes a detector input 310 to detect playback of an optical media such as the DVD-ROM 134. In a particular embodiment, the detector input 310 is provided by the PCRT 130 controller. In response to detecting the playback, the controller 300 provides a control output 320 to the actuator assembly that includes actuator arm 240 and the VCM 250 supporting the head 230. The control output 320 moves the head 230 in a predefined motion, thereby substantially preventing the head 230 from being parked onto the ramp 260.

In a particular embodiment, the predefined motion includes continuously moving the head 230 in a slow sweeping motion. The predefined motion may occur continuously during the playback of the optical media and the predefined motion may be stopped when the playback is stopped. The predefined motion may follow a pattern or may be randomly generated. In a particular embodiment, the predefined motion may include the head 230 moved at a constant speed in-between the innermost track and the outermost track of the disk platter 210. The speed of the slow sweeping motion may be adjusted to avoid generation of unwanted sound or noise.

The predefined motion substantially prevents the head 230 from dwelling at a predefined region of the disk platter 210 for a period that is greater than a predefined period and thereby avoids lube pickup. If the HDD 132 is accessed by a software program executing in the IHS 100 while the head 230 is being moved in accordance with the predefined motion, then the head 230 is positioned to the target track/sector without having to load/unload the head 230 from the ramp 260. After accessing the target track/sector, the predefined motion is resumed. Thus, the long latency time as well as the clicking noise generated by the load/unload operation of the head 230 are avoided during the playback of the movie.

In a particular embodiment, a power management function of the HDD 132 may be disabled during the playback to avoid parking of the head 230. The controller 300 includes a disable output 330 that may be asserted to disable a power management circuit (not shown) of the HDD 132 in response to the playback and deasserted to enable the power management circuit of the HDD 132 in response to a stop in the playback.

FIG. 4 is a flow chart illustrating a method for controlling a storage device, according to an embodiment. In step 410, a detector input indicative of a playback of an optical media is received. In a particular embodiment, the detector input is the detector input 310 described with reference to FIG. 3. In step 420, a head of the storage device is adjusted to move in a predefined motion in response to detecting the playback. In a particular embodiment, the head is the same as the head 230 of the HDD 132 described with reference to FIG. 2. The movement of the head in the predefined motion substantially prevents the storage device from generating an unsolicited sound such as a clicking noise during the movie playback. In step 430, a power management circuit of the storage device is disabled in response to the playback. In step 440, the detector input receives an input indicative of the stop in the playback of the movie. In step 450, the power management circuit is enabled.

Various steps described above may be added, omitted, combined, altered, or performed in different orders. In a particular embodiment, step 430 may be performed before step 420 to avoid the HDD 132 being placed in a standby mode.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A controller to control a storage device, the controller comprising:
a detector input to detect playback of an optical media; and
a control output to move a head of the storage device in a predefined motion in response to the playback.

2. The controller of claim 1, wherein the predefined motion occurs at a predefined constant speed.

3. The controller of claim 1, wherein the predefined motion substantially prevents an occurrence of a load and an unload operation of the head.

4. The controller of claim 1, wherein the predefined motion substantially prevents the head from dwelling at a predefined region of the storage media for a period that is greater than a predefined period.

5. The controller of claim 1, wherein the predefined motion substantially prevents the storage device from generating an unsolicited sound.

6. The controller of claim 5, wherein the unsolicited sound substantially resembles a clicking noise.

7. The controller of claim 1, wherein the predefined motion occurs continuously during the playback of the optical media.

8. The controller of claim 1, wherein the predefined motion is disabled when the playback is disabled.

9. The controller of claim 1, wherein the storage device is a hard disk drive (HDD), wherein the head is operable to read and write data.

10. The controller of claim 1, comprising:
a disable output asserted to disable a power management circuit of the storage device in response to the playback.

11. The controller of claim 10, wherein the detector detects a stop in the playback, wherein the disable output is deasserted to enable the power management circuit in response to the stop.

12. The controller of claim 1, wherein the optical media and the storage device are included in an information handling system (IHS).

13. A method for controlling a storage device, the method comprising:
receiving a detector input indicative of a playback of an optical media; and
adjusting a head of the storage device to move in a predefined motion in response to the playback.

14. The method of claim 13, comprising:
disabling a power management circuit of the storage device in response to the playback.

15. The method of claim 14, comprising:
receiving the detector input indicative of a stop in the playback;
enabling the power management circuit in response to the stop.

16. The method of claim 13, wherein the predefined motion occurs at a predefined constant speed.

17. The method of claim 13, wherein the predefined motion substantially prevents the storage device from generating an unsolicited sound.

18. An information handling system (IHS) comprising:
a processor;
an optical media drive coupled to the processor, wherein the optical media drive is operable to playback contents of an optical media; and
a storage device (SD) coupled to the processor, wherein the SD includes:
a head to read and write data;
a detector input to detect the playback; and
a control output to move the head in a predefined motion in response to the playback.

19. The system of claim 18, wherein the predefined motion occurs at a predefined constant speed.

20. The system of claim 18, wherein the predefined motion substantially prevents the SD from generating an unsolicited sound.
